(19) United States
(12) Patent Application Publication
(10) Pub. No.: US 2013/0155257 A1
(43) Pub. Date: Jun. 20, 2013

(54) TEST DEVICE FOR TESTING CAMERA MODULE AND METHOD THEREOF

(71) Applicant: Chuang-Hua LIN, Tu-Cheng (TW)

(72) Inventor: Chuang-Hua LIN, Tu-Cheng (TW)

(73) Assignee: HON HAI PRECISION INDUSTRY CO., LTD., Tu-Cheng (TW)

(21) Appl. No.: 13/491,620

(22) Filed: Jun. 8, 2012

(30) Foreign Application Priority Data
Dec. 16, 2011 (TW) 100146927

(51) Int. Cl. H04N 17/02

(52) U.S. Cl. 348/187; 348/E17.004

(57) ABSTRACT

A method for testing a camera module includes: making a lens barrel of the camera module to be aligned with a reference picture with a label; obtaining an image captured by the camera module; analyzing the image and identifying the label, and a first central point of the image; determining coordinates of the label and the first central point to obtain coordinates of an imaged label and a second central point of the image sensor, and calculating an actual distance between the imaged label and the second central point according to them coordinates; obtaining a value of an EFL of the camera module; calculating an angle between a center axis of a lens and a center axis of the image sensor according to the actual distance and the EFL; determining that whether the installation of the camera module satisfies the requirement by comparing the angle with a reference angle.

### BACKGROUND

1. Technical Field

The present disclosure relates to test devices, particularly, to a test device for testing a camera module used in consumer electronics.

2. Description of Related Art

As well known, electronic devices with a camera module, such as, digital cameras, mobile phones, digital photo frames, electronic readers, are ubiquitous. Usually, in order to guarantee the quality of the camera module, a test for the camera is needed before leaving the factory. As shown in FIG. 5, a camera module 30 includes a lens barrel 301, a lens 302 located in the lens barrel 301, and an image sensor 303. One important test item is to test whether the relative position between the lens 302 and the lens barrel 301 satisfies the requirement. Usually, the lens barrel 301 and the image sensor 303 are fixed connected to each other, and the center axes of the lens barrel 301 and the image sensor 303 are overlapped. As shown in FIG. 5, if an installation of the camera module 30 satisfies the requirement completely, the optical axis of the lens 302 is overlapped with the center axis of the lens barrel 301 or the image sensor 303. However, FIG. 6, shows, in fact, the installation of the camera module 30 usually has a deviation, namely, the center axis of the lens 302 is difficult to be overlapping with the center axis of the lens barrel 301 and the image sensor 303 when the camera module 30 is produced, and there is an angle θ between the center axis of the lens 302 and the center axis of the lens barrel 301 or the image sensor 303. Therefore, the common method to test whether the installation of the camera module 30 satisfies the requirement is by determining whether the angle θ is in an allowable range. However, the common method and device to test whether the angle θ is in the allowable range is complex.

A test device that overcomes the described limitations is thus needed.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a test device for testing a camera module, in accordance with an exemplary embodiment.

FIG. 2 is schematic diagram showing a scene when a reference picture is captured by a camera module tested by the test device of FIG. 1, in accordance with an exemplary embodiment.

FIG. 3 is schematic diagram schematic diagram of an image obtained by the test device of FIG. 1, in accordance with an exemplary embodiment.

FIG. 4 is a flowchart illustrating a method for test a camera module applied in an test device, such as that of FIG. 1, in accordance with an exemplary embodiment.

FIG. 5 is a schematic diagram showing an installation of a camera module satisfies the requirement completely of a related art.

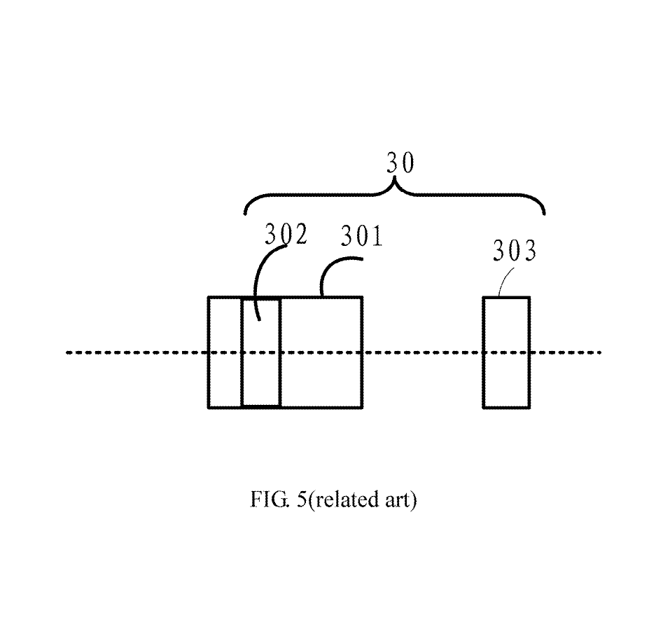

FIG. 6 is a schematic diagram showing an installation of a camera module has a deviation of a related art.

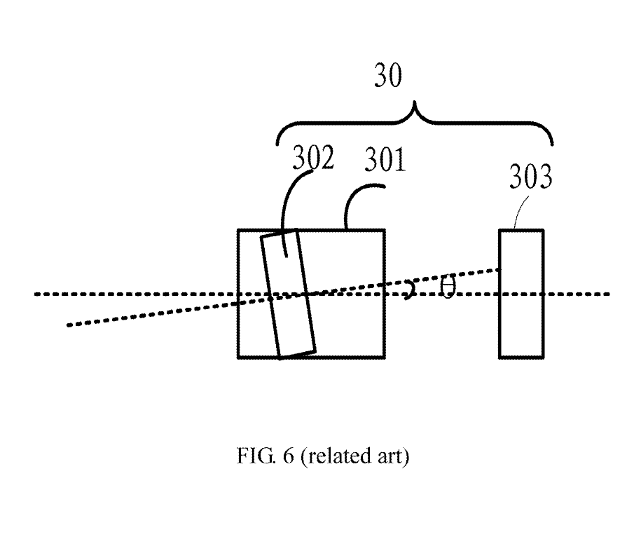

### DETAILED DESCRIPTION

Embodiments of the present disclosure will be described, with reference to the accompanying drawings.

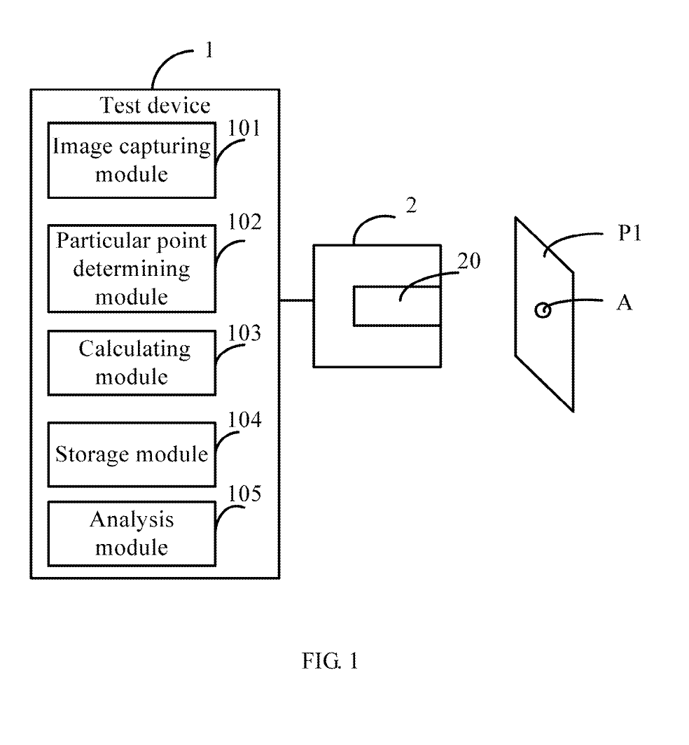

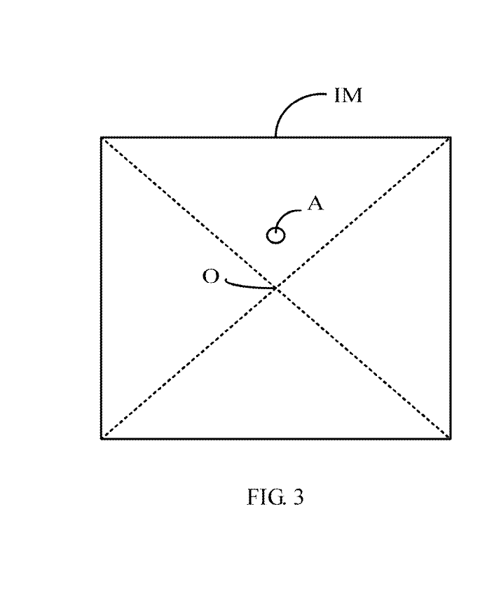

FIGS. 1-3, is a test device 1. The testing device tests whether the installation of a camera module 20, used in an electronic device 2 satisfies general requirements. The camera module 20 includes a lens barrel 201, a lens 202, and an image sensor 203. The lens is located in the lens barrel 201. The test device 1 includes an image capturing module 101, a particular point determining module 102, a calculating module 103, a storage module 104, and an analysis module 105. The storage module 104 stores a value of an effective focal length (EFL) which is a distance between a central point C of the lens 202 and a central point B of the image sensor 203.

The image capturing module 101 obtains images captured by the camera module 20. In the embodiment, the camera module 20 is aimed at a reference picture P1 as shown in FIG. 1 to capture an image IM corresponding to the reference picture P1. As shown in FIG. 1, the reference picture P1 includes a label A, which can be a distinctive object, for example, a colored point, such as a red point, or a small ring set on the reference picture P1 by a user. In the embodiment, the lens barrel 201 is aligned with the reference picture P1, that is, the reference picture P1 is perpendicular to a center axis of the lens barrel 201, and the center axis of the lens barrel 201 passes through the label A of the reference picture P1. In the embodiment, incident lights of the reference picture P1 pass through the lens 202 and transmitted to the image sensor 203 to form images of the reference picture P1, the image capturing module 101 obtains the images formed by the image sensor 203 of the camera module 20.

In the embodiment, the position of the camera module 20 can be adjusted to make the lens barrel 201 align with the reference picture P1. For example, the reference picture P1 is set on the front of the camera module 201, the camera module 20 is placed on a six-axis platform, and the user adjusts the position of the camera module 20 to make the lens barrel 201 align with the reference picture P.

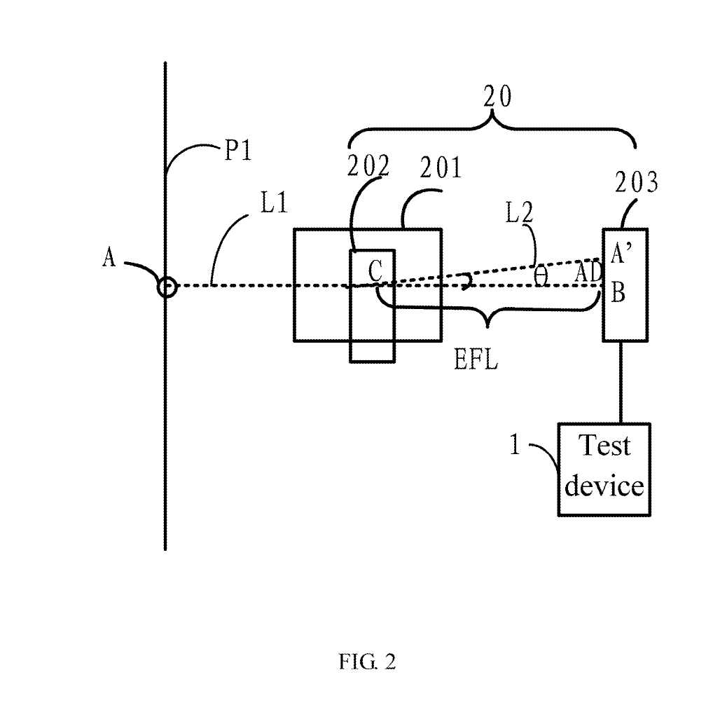

FIG. 2, shows as described in the background. The lens barrel 201 and the image sensor 203 are securely connected to each other, and the center axis of the lens barrel 201 and the image sensor 203 are overlapping, if the installation of the camera module 20 is in the perfect state. In the embodiment, the center axis of the lens 202 is overlapping with the center axis of the image sensor 203 or the lens barrel 201. However, in fact, there is an angle θ between the center axis of the lens 202 and the center axis of the lens barrel 201/image sensor 203. Therefore, an incident light L1 of the label A is refracted by the lens 202 when passing through the central point C of the lens 202 and forms a refracted light L2, and then the refracted light L2 is projected to the image sensor 203 and form an imaged label A′ corresponding to the label A. Obviously, the imaged A′ is not overlapping with the central point B of the image sensor 203. Therefore, the label A of the image IM obtained by the image capturing module 101 is also not overlapping to a central point O of the image IM. It is obvious that an angle between the incident light L1 and the refracted light L2 is equal to the angle θ between the center axis of the lens 202 and the center axis of the image sensor 203/lens barrel 201.

The particular point determining module 102 analyzes the image IM obtained by image capturing module 101, and identifies the label A and the central point O of the image IM. For example, the particular point determining module 102 analyzes image data of the image to determine the arranged distinctive object, such as the red point or the small ring to identify the label A, and then calculates the central coordinates to determines the central point O of the image IM. In the embodiment, each pixel point of the image IM corresponds to one coordinates of a coordinate system, such as a rectangular coordinate system, and each point of the surface of the image sensor 203 corresponds to one coordinates of the same coordinate system. In the embodiment, the size of the image IM is the same as the surface of the image sensor 203, and the coordinates of the points of the image IM respectively corresponds to the points of the image sensor 203. Therefore, the central point O of the image IM corresponds to the central point B of the image sensor 203, and the label A of the image IM corresponds to the imaged label A′ of the image sensor 203.

The calculating module 103 determines the coordinates of the label A, and the central point O of the image IM, then determines the coordinates of the imaged label A′ and the central point B of the image sensor 203, and then calculates an actual distance AD between the imaged label A′ and the central point B of the image sensor 203 according to the coordinates of the imaged label A′ and the central point B of the image sensor 203, and obtains the value of the EFL from the storage module 104, and then calculates the angle θ between the center axis of the lens 202 and the center axis of the image sensor 203 according to the actual distance AD and the value of the EFL.

In detail, as described above, the angle between the incident light L1 and the refracted light L2 is equal to the angle θ between the center axis of the lens 202 and the center axis of the image sensor 203. Because the EFL is the distance between the central point C of the lens 202 and the central point B of the image sensor 203, and the actual distance AD is the distance between the imaged label A′ and the central point B of the image sensor 203, and the imaged label A′ is formed due to the refracted light L2 is projected to the image sensor 203. Therefore, lines A′C, BC and A′B constitute a right triangle, an angle between the lines A′C, BC is the angle θ. Assume the value of the EFL is EFL, then the angle θ is equal to arctan(AD/EFL), namely, θ=arctan(AD/EFL).

In the embodiment, because each two pixel points of the image sensor 203 has a certain actual distance S, the calculating module 103 firstly calculates a coordinate distance D between the imaged label A′ and the central point B of the image sensor 203 according to the coordinates of the imaged label A′ and the central point B. Next the calculating module 103 multiplies the coordinate distance D and the certain actual distance S between each two pixel points to obtain the actual distance AD=D*S. Then the calculating module 103 calculates the angle θ according to the formula: θ=arctan(AD/EFL).

In the embodiment, the storage module 104 also stores a reference angle, the analysis module 105 compares the angle θ with a reference angle to obtain a comparison result, and determines that whether the installation of the camera module 20 satisfies the requirement according to the comparison result. In the embodiment, the analysis module 105 determines that the installation of the camera module 20 satisfies the requirement when the angle θ is less than the reference angle, and determines that the installation of the camera module 20 does not satisfy the requirement when the angle θ is greater than the reference angle.

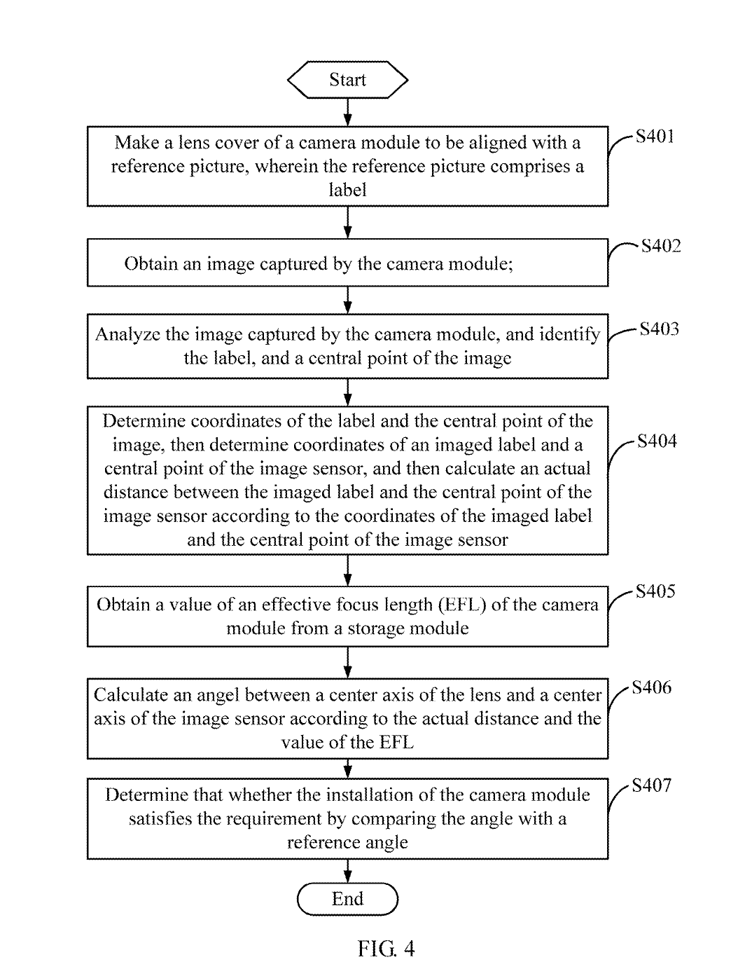

FIG. 4 is a flowchart showing a method for testing the camera module 20, applied in the test device 1 of FIG. 1.

In step S401, the position of the camera module 20 is adjusted to make the lens barrel 201 of the camera module 20 align with the reference picture P1 with the label A. Namely, the reference picture P1 is perpendicular to a center axis of the lens barrel 201. The center axis of the lens barrel 201 passes through the label A of the reference picture P1.

In step S402, the image capturing module 101 obtains the image IM captured by camera module 20.

In step S403, the particular point determining module 102 analyzes the image IM captured by the camera module 20, and identifies the label A, and the central point O of the image IM.

In step S404, the calculating module 103 determines the coordinates of the label A, and the central point O of the image IM, then determines the coordinates of the imaged label A′ and the central point B of the image sensor 203, and then calculates an actual distance AD between the imaged label A′ and the central point B of the image sensor 203 according to the coordinates of the imaged label A′ and the central point B of the image sensor 203.

In step S405, the calculating module 103 obtains the value of the EFL from the storage module 104.

In step S406, the calculating module 103 calculates the angle θ between the center axis of the lens 202 and the center axis of the image sensor 203 according to the actual distance AD and the value of the EFL. In detail, the calculating module 103 calculates the angle θ according to a formula: θ=arctan(AD/EFL).

In step S407, the analysis module 105 compares the angle θ with the reference angle to obtain a comparison result, and determines that whether the installation of the camera module 20 satisfies the requirement according to the comparison result. In detail, the analysis module 105 determines that the installation of the camera module 20 satisfies the requirement when the angle θ is less than the reference angle, and determines that the installation of the camera module 20 does not satisfy the requirement when the angle θ is greater than the reference angle.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A test device for testing a camera module, the camera module having a lens, a lens barrel, and an image sensor, the test device comprising:
a storage module storing an effect focus length (EFL) of the camera module and a reference angle;
an image capturing module, configured to obtain images captured by the camera module, wherein, the camera module is aimed at a reference picture with a label to capture an image corresponding to the reference picture, the reference picture is perpendicular to a center axis of the lens barrel, and the center axis of the lens barrel passes through the label of the reference picture, an incident light of the label passes through the lens and forms an imaged label corresponding to the label on the image sensor;
a particular point determining module, configured to analyze the image obtained by image capturing module, and identify the label and a central point of the image, wherein, the central point of the image corresponds to the central point of the image sensor, and the label of the image corresponds to the imaged label of the image sensor;
a calculating module, configured to determine coordinates of the label and the central point of the image, determine the coordinates of the imaged label and the central point of the image sensor, and then calculate an actual distance between the imaged label and the central point of the image sensor according to the coordinates of the imaged label and the central point of the image sensor, and further configured to obtain the EFL from the storage module, and calculate an angle between a center axis of the lens and the center axis of the lens barrel according to the actual distance and the value of the EFL; and
an analysis module, configured to compare the angle with the reference angle to obtain a comparison result, and determine that whether the installation of the camera module satisfies the requirement according to the comparison result.

2. The test device for testing a camera module according to claim 1, wherein the analysis module determines that the installation of the camera module satisfies the requirement when the angle is less than or equal to the reference angle, and determines that the installation of the camera module does not satisfy the requirement when the angle is greater than the reference angle.

3. The test device for testing a camera module according to claim 1, wherein the calculating module calculates a coordinate distance between the imaged label and the central point of the image sensor according to the coordinates of the imaged label and the central point of the image sensor, and then multiplies the coordinate distance and a certain actual distance between each two pixel points of the image sensor to obtain the actual distance.

4. The test device for testing a camera module according to claim 1, wherein assuming the actual distance is AD, the value of the EFL is EFL, and the angle is θ, the calculating module calculates the angle θ according to the formula: θ=arctan(AD/EFL).

5. The test device for testing a camera module according to claim 1, wherein the label of the reference picture is a colored point or a small ring, the particular point determining module analyzes image data of the image to determine the colored point or the small ring to identify the label, and then calculates a central coordinates to determine the central point of the image.

6. The test device for testing a camera module according to claim 1, wherein the coordinates of the label and the central point of the image are respectively corresponding to the coordinates of the imaged label and the central point of the image sensor, then the calculating module determines the coordinates of the imaged label and the central point of the image sensor are respectively the coordinates of the label and the central point of the image.

7. A method for testing a camera module, the camera module comprising a lens, a lens barrel, and an image sensor, the method is applied in a test device of claim 1, the method comprising:
making the lens barrel of the camera module to be aligned with a reference picture, wherein the reference picture comprises a label;
obtaining an image captured by the camera module;
analyzing the image captured by the camera module, and identifying the label, and a central point of the image;
determining coordinates of the label and the central point of the image, then determining coordinates of an imaged label and a central point of the image sensor, and then calculating an actual distance between the imaged label and the central point of the image sensor according to the coordinates of the imaged label and the central point of the image sensor;
obtaining a value of an effective focus length (EFL) of the camera module from a storage module;
calculating an angle between a center axis of the lens and a center axis of the image sensor according to the actual distance and the value of the EFL;
comparing the angle with a reference angle to obtain a comparison result, and determining that whether the installation of the camera module satisfies the requirement according to the comparison result.

8. The method according to claim 7, wherein the step “determining that whether the installation of the camera module satisfies the requirement according to the comparison result” comprising:
determining that the installation of the camera module satisfies the requirement when comparing the angle is less than or equal to the reference angle; and
determining that the installation of the camera module does not satisfy the requirement when comparing the angle is greater than the reference angle.

9. The method according to claim 7, wherein the step “calculating an actual distance between the imaged label and the central point of the image sensor according to the coordinates of the imaged label and the central point of the image sensor” comprising:
calculating a coordinate distance between the imaged label and the central point of the image sensor according to the coordinates of the imaged label and the central point of the image sensor; and
multiplying the coordinate distance and a certain actual distance between each two pixel points of the image sensor to obtain the actual distance.

10. The method according to claim 1, wherein assuming the actual distance is AD, the value of the EFL is EFL, and the angle is θ, the step “calculating an angle between a center axis of the lens and a center axis of the image sensor according to the actual distance and the value of the EFL” comprising:
calculating the angle θ according to a formula: θ=arctan(AD/EFL).

11. The method according to claim 7, wherein the label of the reference picture is a colored point or a small ring, the step “identifying the label, and a central point of the image” comprising:
analyzing image data of the image to determine the colored point or the small ring to identify the label, and
calculating a central coordinates to determine the central point of the image.

12. The method according to claim 7, wherein the coordinates of the label and the central point of the image are respectively corresponding to the coordinates of the imaged label and the central point of the image sensor, the step “determining coordinates of an imaged label and a central point of the image sensor” comprising:
determining the coordinates of the imaged label and the central point of the image sensor respectively are the coordinates of the label and the central point of the image.
